(19) United States
(12) Patent Application Publication
(10) Pub. No.: US 2006/0080326 A1
(43) Pub. Date: Apr. 13, 2006

(54) Method for reengineering of business processes

(75) Inventors: Kunter Seref Akbay, Niskayuna, NY (US); Richard Paul Messmer, Rexford, NY (US); Christopher Donald Johnson, Clifton Park, NY (US); Navneet Kapoor, Haryana (IN); Marc Pavese, Saratoga Springs, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/959,769

(22) Filed: Oct. 7, 2004

(51) Int. Cl. G06F 17/30

(52) U.S. Cl. 707/100

(57) ABSTRACT

A method for reengineering of a business process. The method includes extracting baseline information requirements of at least one business process, wherein the step of extracting includes interviewing a process owner of each of the sub-processes of the business process based on a predetermined questionnaire and quantifying information requirements of each of the sub-processes of the business process based on the questionnaire. The method also includes displaying the baseline information requirements in a predetermined matrix structure and prioritizing opportunities for removing information bottlenecks in the at least one business process using the predetermined matrix structure.

### BACKGROUND

The present invention relates to a methodology for defining business processes to be used in business systems with an opportunity to reengineer existing functional business areas or across functional business areas by design, construction, and implementation of the defined business processes.

Business process reengineering methodologies have existed in organizational theory for more than a decade. However, facts point out that the majority of these traditional business process reengineering methods have fallen short of achieving their business goals of radical improvement in efficiency and effectiveness of business systems. That raises a question of whether the approach to planning for business process reengineering has been effective. Usually, a process is reengineered around the value chain of the core products or the core services of a business system. The drawback of this approach is that the exercise of reengineering often ends up simply automating an old process and thereby perpetuating the old inefficiencies in a new system.

‘Information’, however, is being increasingly recognized as an organizational resource, fundamentally as important as the core products or the core services of a business system. Likewise, there is an increasingly perceived need for a shift away from analyzing a business process as merely a set of workflows designed to achieve the product or service goals of a business system. Accordingly, there is a need in the art to provide a more effective method and system for process reengineering.

### BRIEF DESCRIPTION

Briefly, in accordance with one embodiment of the invention, a method is provided for reengineering of a business process. The method includes extracting baseline information requirements of at least one business process, wherein the step of extracting includes interviewing a process owner of each of the sub-processes of the business process based on a predetermined questionnaire and quantifying information requirements of each of the sub-processes of the business process based on the questionnaire. The method also includes displaying the baseline information requirements in a predetermined matrix structure and prioritizing opportunities for removing information bottlenecks in the at least one business process using the predetermined matrix structure.

In accordance with another embodiment of the invention, a system is provided to reengineer a business process. The system includes a questionnaire for interviewing an expert for eliciting baseline information requirement of the business process, a number of documents related to the baseline information requirement of the business process, and a matrix to display the baseline information requirement of the business process.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 shows an exemplary flow chart of a business process methodology as is commonly found in prior art;

FIG. 2 shows an information matrix before a business process is reengineered as is explained in an exemplary embodiment of this invention;

FIG. 3 shows an information matrix after a business process is reengineered as is explained in an exemplary embodiment of this invention; and

FIG. 4 shows an exemplary flow chart of a business process methodology as is explained in an exemplary embodiment of this invention.

### DETAILED DESCRIPTION

In traditional business literature, a ‘process’ is defined as a structured, measured set of activities designed to produce a specified output for a particular customer or market. In the same manner, a ‘business process’ is a set of logically related tasks performed to achieve a defined business outcome or a goal. It implies a strong emphasis on how work is done within a business system. Business processes have two important characteristics. First, every business process is meant for a number of customers—internal or external. Second, every business process crosses organizational boundaries, i.e., it occurs across or between organizational subunits, functions or sub-functions. Business processes are generally identified in terms of a beginning and one or more end points. In between, there are many organizational functions or sub-systems involved and also the interfaces between these functions or sub-systems. In fact, customers are often viewed as an extended part of a business system existing beyond an interface meant for exchange of products and services for their value. Some processes have high impact on the business goals of a business system. Conversely, other processes are rather customary in nature and low in impact. High impact processes typically have definite process owners who have the overall responsibility and accountability for smooth running of the processes. Examples of high impact processes include developing a new product, ordering goods from a supplier, creating marketing plans, processing and paying an insurance claims etc. Examples of low impact processes typically include induction plan for new customers, training of the in-house maintenance staff, etc.

Business processes are typically defined based on three dimensions:

Entities: Entities are organizational actors. They start a process, monitor and control it and finally end the process when the objectives are met. Examples of different entities are different individuals, functions, departments, groups, teams and projects etc. Processes take place because of interactions between organizational entities. Depending on the level of abstraction of an entity, a process can be Inter-organizational (e.g. enterprise data integration or an EDI process carried out by a digitization group), Inter-functional (e.g. salary process management between finance and other departments) or Interpersonal (e.g. supply chain management process as followed by the sourcing individuals in the business systems with the suppliers outside the business system).

Objects: Objects are the fundamental units on which the entities act. Processes result in manipulation of objects. These objects could be physical or informational. Examples of physical objects may include products, services, intermediate goods, raw material, etc. and examples of informational objects may include company databases, licensed software packages, and intellectual assets such as patents, trademarks, copyrights, publications, white papers, etc.

Activities: Activities are the building blocks or the steps of the processes. Processes could involve two types of activities: managerial (e.g. developing a budget) and operational (e.g. filling a customer order). Other examples of activities may include budgeting, modeling, simulation, reengineering, etc.

A relevant question in management of business systems is how to identify different business processes. One technique for identifying business processes in a business system is to follow the value chain of one of the fundamental objects of the business operation. A value chain is a set of logical steps by which a low valued object or a raw material is converted into a high valued finished product or service.

Business processes are intended to deliver business goals in the end and at times, these processes come under organizational introspection and detailed scrutiny. The motivation behind such an enquiry can vary over a number of situations, for example under-performance of a business system or one or more of its processes. In other situations, the motivation may be simply an organization-wide desire to excel. The exercise of organizational introspection is often followed by an action plan called ‘business process reengineering’. In literature, ‘business process reengineering’ is also known as ‘business process redesign’ and ‘process innovation’. The primary thrust of such an endeavor is to streamline a business process so that it becomes more effective and thereby helps a business system achieve its business goals.

In other words, ‘business process reengineering’ is a method of analysis and design of workflows and processes within and between business systems. It includes the critical analysis and radical redesign of existing business processes to achieve breakthrough improvements in performance measures. In recent years, increased attention to business processes is largely due to the ‘quality’ movement. Both the ‘quality’ movement and ‘business process reengineering’ share a cross-functional orientation. ‘Quality’ specialists tend to focus on incremental changes and gradual improvements of processes, while proponents of business process reengineering often seek radical redesign and drastic improvements of processes.

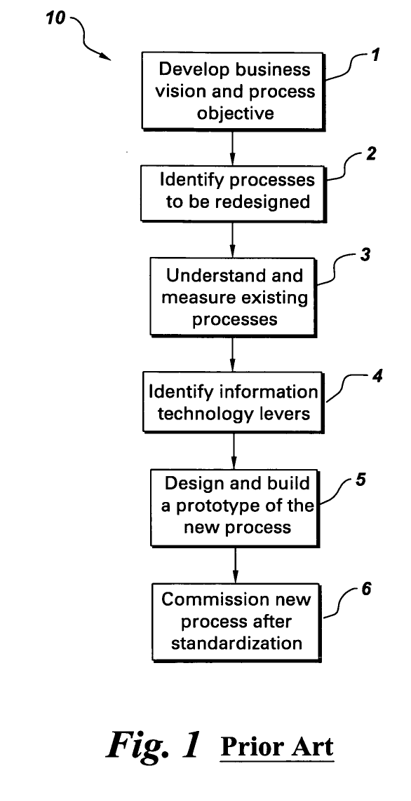

FIG. 1 explains an exemplary traditional method of business process reengineering as is found in prior art. The method prescribes a five-step approach to business process reengineering:

Develop the business vision and process objectives: Business process reengineering is driven by a business vision that implies specific business objectives such as cost reduction, time reduction, output quality improvement, or learning/empowerment. This step is shown in functional block 1 of FIG. 1.

Identify the processes to be redesigned: Most of the business systems use two approaches to identify a process for reengineering. In one approach, the most important processes are chosen for reengineering. In an alternative approach, the chosen processes are the ones that conflict most with the vision of the organization and stand apart from the business context. Comparatively fewer business systems use a third alternative that attempts to identify all the processes within a business system and then to prioritize them in order of redesign urgency. This step is shown in functional block 2 of FIG. 1.

Understand and measure the existing processes: Existing processes need to be understood and measured to avoid repetition of old mistakes and to provide a baseline for future improvements. This step is shown in functional block 3 of FIG. 1.

Identify information technology levers: Awareness of the enabling power of information technology should influence process design. This step is shown in functional block 4 of FIG. 1.

Design and build a prototype of the new process: A new design should not be viewed as the end of a business process reengineering initiative. Rather, the new design should be viewed as a prototype, to be refined with successive iterations. The metaphor of prototype aligns the business process reengineering approach with quick delivery of results, and the involvement and satisfaction of customers. This step is shown in functional block 5 of FIG. 1.

Commission a new process after standardization: A new process should be put into practice only after it is standardized through a number of trials. This step is shown in functional block 6 of FIG. 1.

Business process reengineering methodologies have existed in organizational theory for more than a decade. However, facts point out that many of these traditional business process reengineering methods have fallen short of achieving their business goals of radical improvement in efficiency and effectiveness of business systems. That perpetuates the question of whether the approach has been right while planning for business process reengineering. Usually, a process is reengineered around the value chain of the core products or the services of a business system. The drawback there is that the exercise of reengineering often ends up simply automating the old process and thereby perpetuating the old inefficiencies in the new systems.

As noted above, ‘information’ is being increasingly recognized as an organizational resource, fundamentally as important as the core products or the core services of a business system. Likewise, there is an increasingly perceived need for a shift away from analyzing a business process as merely a set of workflows designed to achieve the product or service goals of a business system. In the same manner, there is a perceived need to move from a view conceptualizing products or services as the core objects of business to an ‘information-oriented’ view while thinking about better organizational efficiency or effectiveness. The rationale behind this thinking is that information, used as a raw material for organizational processes and functions, has its own value chain starting from data and extending on to knowledge and comprehension. Effective management of organizational functions, sub-processes and finally the core business processes is possible by effectively managing information and its flow through a business system.

One embodiment of the present technique focuses on the method of managing information and its flow through a business system. Accordingly, a business system is to be built around the information and communication requirements of a business system instead of a process hierarchy of products or services. The questions that are very vital to the design, survival, operation as well as excellence of any such business system are:

What information is needed to complete the organizational tasks?

From whom, when, and how can this information be generated and procured?

What information needs to be passed on through the value chain because other information is dependent on this information?

In what form and when can this transfer of information happen?

An information-centric model as outlined above, is applicable to any business system that operates in the business world of today's information age. These information-centric models are built around the technology, organizational culture or philosophy as well as the people of such business systems. The key to unleash the vast potential contained in any business system is to identify, connect and integrate different parts of a value chain of information, that otherwise exist as isolated bodies of information. A business system enables itself to solve problems by building an environment where all the information resources are shared. The vision of a business system is easily realized through an ongoing collaboration of different entities when the information resources are shared. This can be done by having multiple data warehouses, all widely available and interacting together with clearly defined and shared definitions of data. The new way of doing business is to recognize information as power and then to distribute the information in order to unleash that power. This way, everyone within a business system is empowered to execute his task. Thus, an exercise of business process reengineering in accordance with one embodiment, is essentially a process of ‘information reengineering’.

A value chain of information can be compared with a traditional value chain of products or a value chain of services by comparing different physical and informational models of business systems. In a physical model, raw materials enter a business system and leave as finished goods. For example, in a manufacturing based business system, raw materials are converted into finished products of daily use at the end of their value chain. On the other hand, in an informational model like an internet-based ‘electronic commerce’ or e-Commerce system, information is value-added through different stages. In this informational model, raw information enters into a business system and leaves as processed information. This way, ‘electronic commerce’ is an on-line production process driven by information and owned by different intermediaries at different stages of transactions. Examples of intermediaries in case of a typical e-commerce process include the internet service provider, the internet site owner, the internet product (or service) wholesalers, the retailers, the dispatchers, decision makers, etc. Producers of information interact with services and other processed information, such as orders, payments or instructions.

In reality, ‘electronic commerce’ is an ideal example of business systems and consumers adopting a new process or methodology structured around information. These processes, as a point of departure from the physical models of business systems, are typically supported by electronic interactions. These electronic interactions eliminate any need of close physical presence of the interacting objects or a similar need for the objects to be present at the same time or in the same ‘time-zone’ or any such other traditional restrictions. Sometimes, electronic interactions can create altogether new patterns of interactions, for example the ‘one-to-many’ or ‘many-to-one’ bidding interaction that is the norm for electronic auctions.

Recorded facts related to organizational business systems are classified into four categories as commonly known in the art:

Data: Data is understood in terms of a number of symbols or alphabets or numbers.

Information: Information is data that are processed to be useful for providing answers to ‘who’, ‘what’, ‘where’, and ‘when’ questions in relation to operation of a business system.

Knowledge: Knowledge is the application of data and information to answer the ‘how’ questions in relation to operation of a business system.

Comprehension: Comprehension is appreciation of ‘why’ questions in relation to operation of a business system.

Data is raw in form and meaning. It simply exists in isolation and has no significance beyond its existence. It can exist in any form, usable or not. It does not have meaning of itself. In an informational business system, a spreadsheet generally starts out by holding data in each of its cells. In a physical business system, examples of data may include ‘daily sales figures’, ‘weekly production level of a machine shop’, ‘manpower count of a department’, etc.

Information is created as data progresses along its value chain. Information acquires its ‘meaning’ by way of relational connection between constituent data sets. In an informational business system, a relational database holds information based on the data stored within it. In this example, the information contained in the relational database derives its meaning from the numerous data sets and their interrelationships. In a physical business system, a ‘balance sheet’ or a ‘profit and loss account’ or ‘monthly inventory level chart’ are examples of information derived from isolated data on sales, profit, cost, etc.

Knowledge is an appropriate collection of information such that its intent is to be useful. Knowledge is a deterministic body of information organized synergistically and knowledge has useful meaning in its relevant context and system. At the same time, knowledge is a static entity on its own and there is no scope of new knowledge to be generated from an existing body of knowledge. In an informational business system, most of the applications used in business systems, e.g. modeling, simulation, etc. are built around some type of stored knowledge. In a physical business system, an annual report, a process control chart, a ‘quality’ document etc. are examples of knowledge derived from synthesis of information.

Comprehension is an interpolative and probabilistic process. It is cognitive and analytical. It is the process by which new knowledge input in a system is synthesized with previously held knowledge to generate additional knowledge. The difference between comprehension and knowledge is the difference between ‘learning’ and ‘memorizing’. Business systems endowed with power of comprehension can undertake useful actions because they can synthesize new knowledge or in some cases, at least new information, from what is previously known and internalized. In other words, comprehension can build upon currently held information, knowledge and comprehension itself. In an informational business system, artificial intelligence systems possess comprehension in the sense that they are able to synthesize new knowledge from previously stored information and knowledge. In the context of a physical business system, a strategy document, a vision statement, a business process reengineering plan etc. are examples of comprehension as obtained by internalizing and synergizing information.

Continuing to deliberate on value chain analysis, a value chain of a fundamental organizational object is meaningful in a business context only when the end of the value chain is closely aligned with the business goal of a business system. This same principle applies for an information value chain as well. It should be appreciated that knowledge about different ‘information requirements’ of a business system is the basic object that drives any business process reengineering exercise. However, ‘information requirements’ as mentioned in this embodiment are not about the whole range of information available to a business system and its operations, but only the information relevant to the business goals of a business system. For instance, any information regarding the physical composition of the products of a business system may be linked with the business system, but it may not be relevant to the business goal for instance, higher profitability in a financial year. So this information is not fit to be considered for ‘business process reengineering’. In other words, an ‘information requirement’, as the driving force for ‘business process reengineering’ has to relate to the ‘goals’ of a business system and its processes, sub-processes and functions and help to achieve them.

While talking about an ‘information requirement’, it is often taken to be synonymous with ‘information technology’ or digitization. That does more harm than good to the basic tenet of business process reengineering. In prior art, there has been skewed importance attached to digitization, thinking it is the final solution. However the point that is missed is that digitization is meaningful only when it manages the right information in a right way. Processes tend to get only ‘automated’ and not reengineered as a result of digitization, as prescribed by traditional business process reengineering methods.

In operation, instead of digitizing a process to improve it, the need is to improve the process first and then to digitize it. Information technology, considered the key enabler of business process reengineering, is useful in cases where radical organizational changes are desired. Appropriate use of information technology challenges the assumptions inherent in any work process that have existed since long before the advent of modern computer and information technology. Many of these rules of work design are based on assumptions about technology, people, and organizational goals that no longer hold true. At the heart of present day reengineering is the notion of ‘discontinuous thinking’—or recognizing and breaking away from the outdated rules and fundamental assumptions underlying operations. Thus, while mapping the ‘information requirement’ of a business system, there is need to start from scratch irrespective of whether there is an existing process or a new process is being designed.

The present technique for business method reengineering builds on the following cardinal principles of reengineering as originally propounded by Michael Hammer in 1991:

(a) Organize around outcomes, not tasks;

(b) Have those who use the output of the process perform the process;

(c) Subsume information processing work into the work that produces the information;

(d) Treat geographically dispersed resources as though they were centralized;

(e) Link parallel activities instead of integrating their results;

(f) Put the decision point where the work is performed, and build control into the process; and

(g) Capture information once and at the source.

The set of principles presented above drive deeper the need of mapping the ‘information requirements’ first and then sharing the mapped information across a business system. In other words, business process reengineering does not start with digitization, but with ‘information requirement’ mapping. A pertinent point is who gives the opinions, feedback and suggestions regarding each ‘information requirement’. There are alternative sources of these opinions, feedback and suggestions. For example, ideas and opinions regarding ‘information requirements’ can be collected from the owners of different business system owners or different process task executives. In some other situations, ideas about ‘information requirements’ can also be generated from knowledge of existing processes or from the developing plans of new processes. However, most of the time, the process owners are likely to indicate the most accurate information requirements as they are responsible and accountable for their processes. So it is an effective step to consult the process owners at an early stage of ‘information requirement’ mapping.

In essence, business process reengineering as explained above requires taking a broader view of both information technology and business activity. This view thrives on the relationship between information technology and business activity. According to this embodiment of the technique, information technology should be viewed as more than an automating or mechanizing force. The all-pervading power of information technology is to be used to reshape the fundamental ways of doing business. That is the rationale behind proposing that any business process reengineering should start from scratch by first defining the critical information requirements.

In a similar manner, to maximize their effectiveness, business activities should be viewed as more than a collection of individual or even functional tasks in a process view. Information technology and business process reengineering have a recursive relationship. Information technology capabilities usually support business processes and business processes need to be enhanced with the help of capabilities that information technology can provide. Business processes enhanced by harnessing the enabling power of information technology represent a new approach to coordination across a business system. The ultimate impact of information technology is the most powerful tool for reducing the costs of coordination.

In accordance with one embodiment, the first step of a business process reengineering exercise is extracting baseline information requirements of a business system. Extracting baseline information requirements starts with identifying a set of high level and core processes of the business system for reengineering. Next, process maps are obtained for each of the identified high level and core processes. At the same time, all forms and documents used in each of the high level and core processes are also obtained. In the next step, process owners of each of the identified high level and core processes are interviewed using a standardized questionnaire. Subsequently, the baseline information requirements of each of the identified high level and core processes are quantified for next level analysis. Typically, the process owners are interviewed based on the following questions to elicit the information requirements of their respective processes:

What information is needed?

Why it is needed?

How it is obtained?

How is it used?

An example of the information requirement may be a ‘procedural questionnaire checklist.’ In capturing the information to define the processes and the related information structure, the disclosed embodiments of the business process engineering uses checklists and questionnaires. The questionnaires are tools to query the process owners about who performs the process or procedure, what the process or procedure does, what prompts it to be performed, how it is performed, and the like. Mapping each ‘information requirement’ helps to define the business processes into specific task or decisions through successive levels of details. As an example, if applied to the function of human resource management function in a business system, typical ‘information requirements’ mapping facilitates development of blueprints of job/skill/business system/information technology/management systems in the beginning stages of ‘business process reengineering’. Detailed process diagrams and descriptions may be derived from these ‘information requirement’ maps in the next stage to communicate how the business process may operate in the future.

In this embodiment, the questionnaire serves as a template for the business process engineering model and for further actions within the disclosed methodology. The questionnaire is broken into fields that pertain to discrete subjects for that particular process. For example, the questionnaire asks for procedural roles and responsibilities, which are used in business systems for enhanced efficiency. In another embodiment, the questionnaire also asks for a procedural description that is used to create the business functional specifications. In yet another embodiment, the questionnaire also requests procedural information, such as specialized skills needed, lead time, duration and frequency to create training materials during the construction phase and to hold training during the implementation phase. Further, in another embodiment, the questionnaire asks for information on deliverables and performance measures to measure the success of implementation during the post-implementation phase.

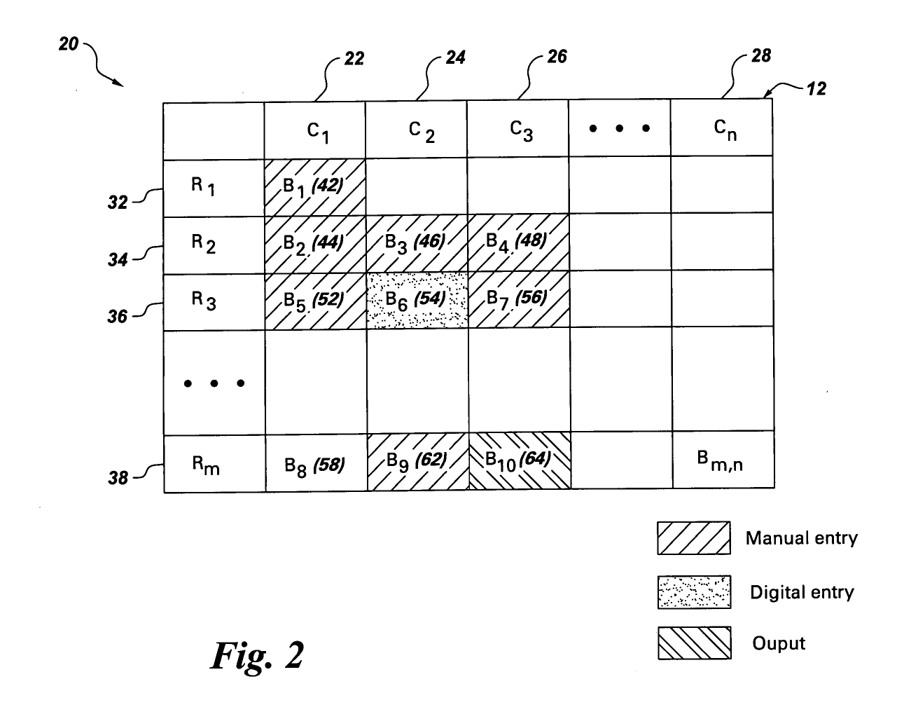

As part of the extracting step, several approaches may be used for determining ‘information requirements’ of a business system. For each major activity with the disclosed methodology, a comprehensive list of events, decisions, and tasks are created. The list is captured on a matrix, such as an MS-Excel spreadsheet and arranged according to a logical or optimal process flow. FIG. 2 shows one such information matrix before the business process it represents is reengineered as is explained below with respect to an exemplary embodiment of this technique. Each step or decision is assigned a serial number after the order of activities is decided. These are arranged in the columns of the spreadsheet in FIG. 2. When appropriate, opportunities are identified to complete tasks in parallel. For each task, event, or decision on the chart, contingencies, issues, integration points, information requirements, process measures, resource allocation, rules, and assumptions are identified and recorded so as not to lose or overlook this information. The process is broken down into all the detailed sub-tasks and decisions, and they are arranged into a logical order. For unknown issues or areas where multiple solutions may exist, alternatives may be developed and noted on the new process diagrams.

For decision steps within the process map, additional information is captured. These are arranged in the rows of the spreadsheet in FIG. 2. The additional information may include job roles, decision criteria, variables or inputs to observe, information required to make the decision, location of the information (for example, a specific computer system or individual), communications outputs of the decisions and their locations, decision rules, legal or regulatory restrictions, organizational restrictions, decision frequency, and the like. After capturing this information, the data may be documented.

At the same time, an ‘information requirement’ map helps one to understand all the entities, objects and activities related to the mapped process or processes and any special significance of any particular entity or object or activity. For example, a ‘process trigger’ is the first entity in the business system that sets off the process under consideration. Similarly, a ‘process customer’ is the final beneficiary of the process. These concepts, entities, objects and activities are referred to in more details in the context of the next steps of the business process reengineering method.

The techniques are not limited to the above-described questionnaire as a means of extracting baseline information. In another embodiment, a survey or a personalized interview method is used to collect all relevant information. In other embodiments, there are different modes of responding to the questions. For example, in an informational business system, respondents may respond through web pages. On the other hand, in the context of a physical business system, respondents may use anonymous response sheets, voice mails, option votes, etc. to voice their opinions, suggestions and feedback.

There are different systems and tools that go with this method. The simplest form of the system 20 of FIG. 2 embodies the business process reengineering method in an information matrix 12. The information matrix 12 is shown the way as it appears after the ‘information requirement’ of a business system is mapped but before the process is reengineered. Each of the columns 22, 24, 26, 28 represents a step or a decision of a process or a function of a business system. These steps are taken from the standardized information collected from different process owners using the questionnaire described above. For example, if information matrix 12 is taken to represent a market intelligence system, column 22 is the first step of ‘customer registration’ in a marketing information building process. In the same manner, 24 is the second step of ‘making cold calls’ to the same customers, 26 is the third step of ‘opening a product offer to the same customer’ etc. Each of the rows 32, 34, 36, 38 represents a data or information need related to a business system or a process of a business system. In the market intelligence system example, 32 is ‘name of sales person’, 34 is ‘customer reference number’, 36 is ‘customer office code’, and 38 is ‘individual vs. corporation status’.

The information matrix 12 contains ‘m’ number of rows R1, R2, R3 to Rm, numbered respectively as 32, 34, 36 and 38. Similarly the information matrix 12 also contains ‘n’ number of columns C1, C2, C3 to Cn, numbered respectively as 22, 24, 26 and 28. There are cells formed at the intersection of the rows and the columns. For instance, cell B1 (numbered as 42) is formed at the intersection of row R1 and column C1. In the same manner, there are other cells B2 (44), B3 (46), B4 (48) and Bmn (66) marked on the information matrix.

The second step of the business process reengineering method in accordance with one embodiment is ‘displaying the baseline information requirements’ extracted in the previous step as described above. The objective of the displaying step is to bring out clearly and visually all the inherent and non-obvious relationships between different entities, objects and activities of a process. When properly displayed, gaps or unexpected irregularities act as pointers to the bottlenecks in the system. The step of displaying the baseline information requirements uses different display modes like color codes, hatching patterns, or such other identifying techniques as are known in the art to highlight and distinguish different information contained in the rows, columns and cells of the information matrix 12. The step derives its contextual meaning from the interpretation of the display mode associated with rows, the columns and the cells positioned at the intersection of the rows and the columns. This is explained in more details below.

Each of the cells 42, 44, 46, 48 etc. in FIG. 2 displays the modes of information capture related to the relevant row and the relevant column. For example, in this embodiment, there are three different modes of information processing represented in the information matrix 12—a cross hatching pattern signifying ‘manual entry’, a ‘dot-filled’ pattern signifying ‘digitized entry’ and a horizontal hatch pattern signifying ‘output information’. As illustrated in FIG. 2, the cell 42 of the information matrix 12 is shown with a cross hatching pattern. This means that the ‘name of the sales person’ as applied to the first step of ‘customer registration’ is entered into the records manually. Similarly, the cell 44 at the intersection of row 34 and column 22 is shown with horizontal hatch pattern. This means that the ‘customer reference number’ for the first step of ‘customer registration’ is a final output of the system. The information matrix 12 thus contains data related to different steps, their relevant information types as well as the mode in which the information is gathered and used.

One will appreciate that the information related to different processes of a business system is captured first, in a rudimentary form in an MS-Excel sheet like a special matrix format as explained FIG. 2. Different rows in another embodiment represent the types of information like ‘customer name’, ‘car type’, ‘lease terms’ etc. and the columns represent the process, where the information is used.

The invention, however, is not limited to the above-described hatching patterns as means of displaying baseline information. In another embodiment, color codes in orange, green and blue are used respectively to signify manual entry, digitized entry, and output. In yet other embodiments, information modes are differentiated by using different shading patterns, cell textures, ‘mouse-over’ options, symbols, animation, or other display attributes known in the art. Further, in yet other embodiments, more sophisticated structures may be used to capture the data and their relationship. Examples of such structures can include data warehouses, database structures, etc. Similarly, less sophisticated structures may be used, including different charts, standards, tables, look-up manuals, specifications, etc. used in different traditional business systems.

One such embodiment displays information by making the data from different systems available in an accessible form to all different functions in different processes that interact with each other. There are different methodologies to make the ‘data warehousing’ concept work in different business systems. The goal of such ‘data warehousing’ methodologies is to provide easier access to information, focusing on specific business needs rather than historic databases.

Referring back to the information matrix 12 in FIG. 2, the status of the processes is reflected as it appears before the process is reengineered. Information bottlenecks are glaring here and the initiatives taken to remove them will steer the system toward an ideal process. For example, referring to the particular information matrix 12 of FIG. 2 an information bottleneck exists here because of repetitive entry of manual information. That gives rise to information duplication and chances of error as well as being a waste of organizational resources. So there is an opportunity for removal of this bottleneck.

One way to remove this information bottleneck is to identify the information that is being repeatedly entered manually and then to digitize that information in the beginning of the process. In the visual representation by information matrix 12 in FIG. 2, this amounts to selecting the rows that contain repeated manual entries and configuring them to contain digitized entries. However, each such opportunity demands its own resource needs, management and time frame for implementation. That is why there is an organizational need to prioritize the competing opportunities of removal of information bottlenecks. The road to the ideal process goes through the step of prioritizing opportunities for removal of information bottlenecks.

According to one embodiment of the invention, at the end of the ‘displaying’ step, the reengineering team arrives at an ‘AS IS’ process map based on different responses from different process owners. Such an ‘AS IS’ map depicts the flow of work that is currently performed by the business in response to an event and it documents interactions between different roles and business system functions. In analyzing the process in an ‘AS IS’ map, a start point and end point for each map is defined.

In an alternative embodiment of the invention, business process engineering starts with one or more existing ‘AS IS’ process maps, and then seeks to improve the ‘AS IS’ process by envisioning a new reformulated process to achieve the objective. According to this embodiment of the invention, the reengineering team uses existing ‘AS IS’ maps for constructing an information matrix and then proceeds directly to define the new re-engineered processes. These new processes are called ‘TO BE’ processes. A ‘TO BE’ process is the final desired form of the business process that is considered an ideal, or at least improved, process for delivering the business goals of the business systems.

The ‘AS IS’ process map is used to gain a common understanding of the current practices, outcomes, and triggers in the process. The ‘AS IS’ process map describes how things are completed at present and provides a baseline of references to measure the effectiveness of new processes that may be developed during their evaluation stages. Several approaches are used during mapping of current processes to identify and baseline all relevant parameters and understand the process, including, but not limited to: identifying current process triggers; identifying key process outcomes for the current process; identifying major activities within the current process; developing a list of the current process problems or areas to be improved upon; and capturing metrics and measures for the current process.

An ‘AS IS’ process map as described above is analyzed for the business process engineering sequence. At a business system level, business system context diagrams are constructed and critical business issues and critical processes are confirmed. At a process level, the current process is mapped and potential disconnects are identified and analyzed. At a procedural level, the detailed functional and technical activities and tasks are identified.

In other embodiments, the ‘displaying’ step and its associated system includes data management strategies that follow from the information strategies and the business strategies of a business system. The business system needs to make decisions about how data will be used to point out the information bottlenecks and to serve the system's business and information needs. The system needs to define its current and future needs for accumulation, usage, renewal, maintenance, and transfer of data within, and outside of, the business system's boundaries. From a business perspective, the system may include:

databases to facilitate surveillance and scanning of the environment;

use of databases for reverse competitive intelligence;

data mining for gathering data on customers and competitors;

data protocols for using EDI for inter-organizational information systems or for electronic integration of a business system's business processes with those of its business partners.

From the information perspective, the system may include:

distributed databases to provide a common view of data across a business system;

data integrity and security;

data warehousing that considers a business system level data requirements;

data modeling tools;

development tools such as CASE and Lotus Notes;

databases, data dictionaries, and query languages.

The third step of the business process reengineering method is ‘prioritizing opportunities for removing information bottlenecks’. Referring to FIG. 2, the step of prioritizing opportunities for removing information bottlenecks is based on the different modes of information handling represented the hatching patterns of the information matrix 12. Moreover, the processes may be reengineered on the basis of various decision criteria. At the end of the ‘prioritizing’ step, based on the decision criteria described above, the process owners arrive at a detailed plan for a desired ‘TO BE’ process. This “TO BE” process map is carved out of the ‘AS IS’ process that has been mapped, displayed, shared and prioritized in the earlier steps. There are also different ways to arrive at the final ‘TO BE’ process.

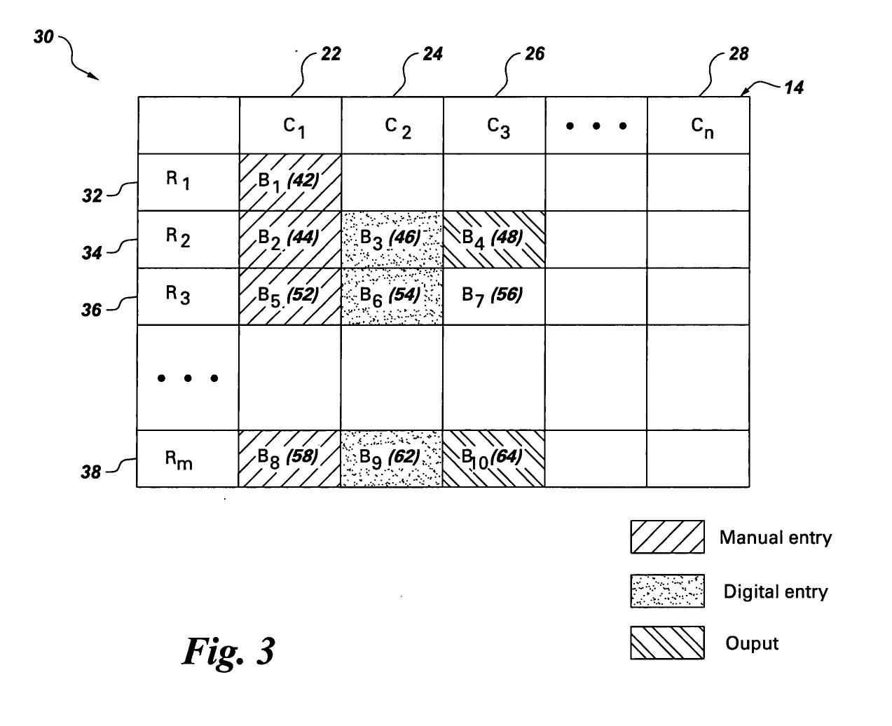

Referring to FIG. 3, the information matrix 14 is a reengineered form of the initial information matrix 12 of FIG. 2. Prioritizing opportunities to remove information bottlenecks starts with looking for the ‘density’ of the cross-hatched (or orange) cells in a given row. Any row with multiple cross-hatched (or orange) cells indicates that the same data or information is needed in many processing or decision steps but the data or information is captured manually more than once during these processing or decision steps. This repetition of manual capturing of data is an ‘information bottleneck’ in a process or decision that slows down the whole process or decision. In an eventuality like this, there is an opportunity to eliminate the ‘information bottleneck’ by digitizing the specific data or information in the first step of the process or decision. In operation, the bottleneck may be removed by capturing the information, either digitally or manually, in the beginning of the process or decision and then sharing it across all subsequent steps. The information matrix 14 obtained in the third step above provides a very effective way to quickly visualize information requirements and the opportunities for removal of information bottlenecks across functions within a transactional business system. An ideal process captures this information only once in the beginning and uses that information throughout the rest of the process. An information matrix corresponding to this ideal would have only one column of cross-hatched (or orange) cells with the rest of the matrix containing only other types of cells. Therefore, the objective is to reengineer processes such that the number of orange cells in a given row is minimized.

Visually, as seen in FIG. 3, many of the cells, for example, B3 (46) and B9 (62), in such reengineered rows like C2 (24) have changed their hatching patterns from ‘cross-hatched’ to ‘dot-filled’, or if stated in terms of color codes, from orange to green. This signifies that many manual entry steps that existed before the reengineering are replaced in the reengineered form of the process by capturing the required information at the beginning of the process and making that information available to the process executive digitally through the rest of the process. In effect, the reengineering exercise has been able to remove an information bottleneck as mentioned earlier. Other than the appearance of the cells in the information matrix 14, the function of the business system 20 is substantially similar to that of the business system 10 shown in FIG. 2. Rows, columns and cells in business system 20 that are identical to rows, columns and cells in business system 10 are identified in FIG. 3 using the same reference numerals used in FIG. 2.

As mentioned earlier, different decision criteria may be used based on which processes are reengineered. One such decision criterion, in accordance with one embodiment, is to achieve the objectives by minimizing non-value adding steps within the processes. The disclosed embodiments also may minimize mid-process handoffs to discrete objects that may result in delays and errors. The disclosed embodiments may also minimize second party approvals. The disclosed embodiments may also minimize unnecessary authorization steps that result in delay. The disclosed embodiments may also minimize manual reconciliation, promote automatic reconciliation to quicken the processes, and decrease error ratio. Moreover, the disclosed embodiments may harness technology by maximizing the value derived from an investment in a computer network or other information technology infrastructure and provide universal access to information at the right time.

Another criterion for prioritizing the opportunities for removal of information bottlenecks is based on the input/output relationship of different elements of the business process. Any process should have at least one input and at least one output. Outputs may be defined as services delivered, including cost, quality, and timeliness. Outputs may include form, content, and frequency of information. Inputs may include information, materials, and equipment. The process may also have throughputs, such as the primary parties involved, the number of hand-offs between parties, and the technologies and methods used, anticipated or required.

In yet another embodiment, the prioritizing criterion for reengineering the sequence is based on process modeling and prioritizing the opportunities for removal of information bottlenecks. The process model is a basic building block of the redesign. According to this embodiment of the invention, process modeling is also used to arrive at the ‘TO BE’ processes. Approaches to process modeling may include identifying the major activities required to link process triggers to process outcomes, identifying the metrics that will be used to measure the performance of the new process, and plotting major activities on a visual chart that may be arranged in an order based on the process flow. Other approaches may include adjusting and altering the order of the activities to optimize critical measures for the process, determining a final process model by identifying dependencies, parallel activities, major decision points, and the like.

At the end of the ‘prioritizing’ step, based on various different decision criteria described above, process owners arrive at a detailed plan of a desired ‘TO BE’ process that is to be carved out of the ‘AS IS’ process mapped, displayed, shared and prioritized in the earlier steps. Approaches to redesign include identifying and naming the process being redesigned, identifying triggering incidents that begin the process, identifying the outcomes that result when the process is completed, identifying the roles of persons and departments taking part in execution of the process, and documenting the information captured above. As noted above, business process engineering seeks to radically improve an ‘AS IS’ process and implement a ‘TO BE’ process.

At this stage, the reengineering team seeks to enhance a business system with a ‘TO BE’ process that is implementable. Several processes are implemented and enhanced through business process engineering according to the disclosed embodiments. A new process is designed or an existing process is redesigned according to the disclosed embodiments. The business reengineering team and the process owners may work together to implement the ‘TO BE’ process in each business system. At this stage, much of the planning goes into detailing a set of structured process steps to enable transitioning from an ‘AS IS’ state to a ‘TO BE’ state in a phased approach. Typically, process owners themselves may be able to coordinate organization-wide change management activities, as they are aware of the differences between current practices and newly designed processes. When implemented, the resulting ‘TO BE’ process supports business goals and meets customer expectations. The resulting process is also fast, focused and flexible. In a typical situation, a workgroup is organized next with the collective expertise to plan, coordinate, control, and troubleshoot its own work.

A more complete and balanced view of the role of information technology or digitization appears at the implementation stage. It is evident at the end of a reengineering process, that by its framework, information technology is instrumental in reducing the degree of mediation and enhancing the degree of collaboration between different functions, sub-processes, process owners, process participants and last but not least the process customers i.e., the final beneficiaries of the process. Moreover, innovative uses of information technology in most of the cases would lead many business systems to develop new, coordination-intensive structures. These coordination-intensive structures enable traditional business systems to coordinate their activities in ways that were not possible before reengineering. Such coordination-intensive structures may also raise the capabilities and responsiveness business system, leading to potential strategic advantages. Example of one such physical process of a manufacturing business system that can be reengineered by the power of digitization is a just-in-time supply chain management process. In a reengineered process, production plans automatically update related inventory data and the sourcing function and the suppliers are contacted as soon as the level of inventories fall below the reorder points. A similar example of an informational process may be an ‘online trading’ option a bank may be able to offer to its customers. In a reengineered process form, news alerts about new share options are automatically sent to the mailboxes of the customers, they are encouraged to work out their own portfolio by online computations and finally after a number of intermediate steps, the monetary value is transferred directly from or to the online account of the participating customers of the bank.

In another embodiment, one new way of using information technology is to use a simulation approach to perfect the ‘TO BE’ process while keeping the business goal in mind. Simulation is done on an ideal ‘TO BE’ process that is modeled based on the information requirement map prepared with the help of the process owners in an earlier step and subsequently digitized. The user of the simulation package describes the internal company processes and then explores ways to reduce the time required to perform an activity or reduce costs associated with an activity whatever be the related business goal of the business process reengineering exercise.

In each of the examples about the use of simulations, the developer of the simulation identifies a specific problem that needs to be addressed, collects initial data about the nature of the operation to be simulated, acquires and learns how to use the simulation package, creates the simulation in the simulation package, and then runs simulations to explore solutions to the specific problem being studied under different ‘what-if’ and ‘do-what’ situations.

The sequence of steps required to make proper use of a simulation package must be carefully carried out. If one creates a simulation based upon faulty data, the simulation results are not reliable. Likewise, if the reengineering team does not understand how to correctly create the simulation, then the effort consumed to make use of simulation packages is misspent. There are different possible simulation techniques that are used in different embodiments like Monte Carlo simulation and discrete event simulation, among others known in the art.

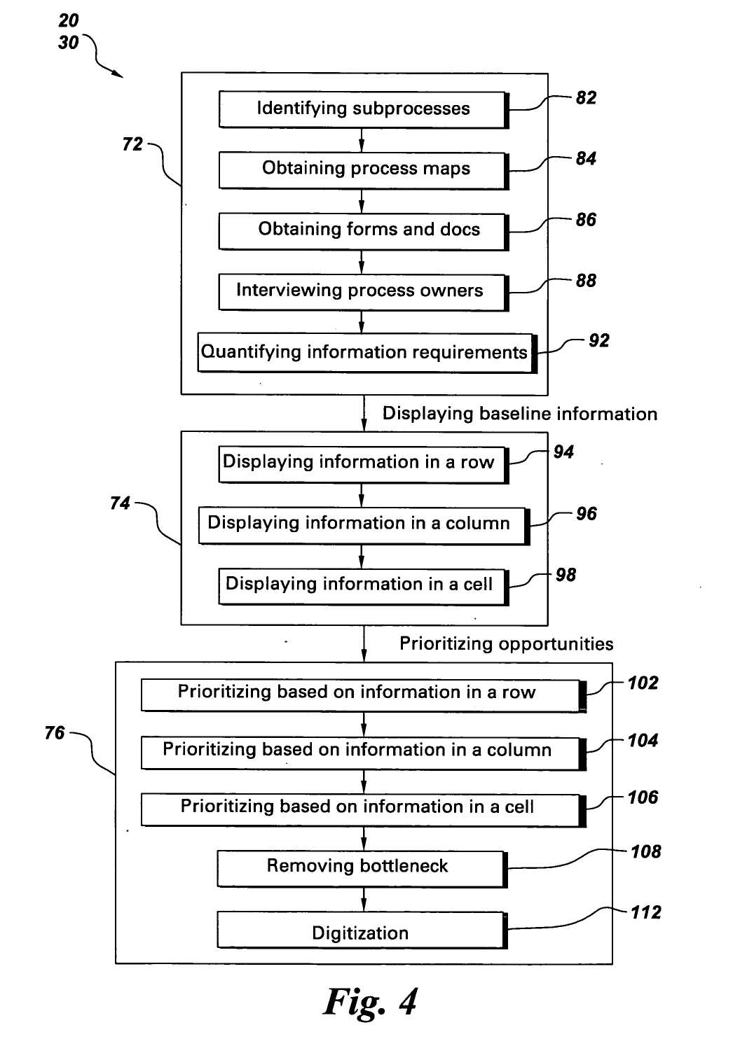

The overall method of business process reengineering in accordance with one embodiment is explained in FIG. 4. The method starts with extracting baseline information of a business system as in functional block 72. The extracted baseline information is displayed as in functional block 74. Based on the baseline information displayed, opportunities for removal of information bottleneck are spotted and prioritized as in functional block 76.

The step of extracting baseline information includes identifying all important high level and core processes of the business system as in functional block 82, obtaining process maps for each of the high level and core processes as in functional block 84 and obtaining forms and documents used in each of the high level and core processes as in functional block 86. Extracting baseline information finally includes interviewing process owners as in functional block 88 and quantifying the information requirements of the business system as evident from the responses of the process owners as in functional block 92.

Similarly, the step of displaying baseline information includes displaying information in a row as in functional block 94, in a column as in functional block 96 and in a cell as in functional block 98. Display of the information in the rows, columns and the cells help identify the information bottlenecks in the process of the business system. In the next stage, opportunities for removal of the information bottleneck are prioritized based on cell information as in functional block 102, column information as in functional block 104 and row information as in functional block 106. After removal of all the information bottlenecks in the process as in functional block 108, the reengineered process is taken up for digitization as in functional block 112.

The method of business process engineering as exemplified in this embodiment is practiced to reengineer a quote process for digitization. The method of business process reengineering as exemplified herein helps identify what information is needed by different functions in a process, for example credit, sourcing, pricing, finance, etc. and the level of effort needed to get this information. The overall process is reengineered subsequently such that all necessary information is obtained once at the beginning of the process and then made digitally available to different functions in parallel to reduce cycle time to complete a quote.

The techniques described herein are not limited to the above example of a transactional business system and can be used in any transactional business systems e.g. insurance processes, core processes, quotation processes, etc. In other embodiments, non-transactional business systems are also reengineered following the method of business process engineering described above. Examples of such non-transactional business systems include traditional manufacturing processes and many other system diagnosis or maintenance processes. Moreover, digitization is not a mandatory element of the business process reengineering method described here. There are other embodiments, where a manual process or a semi-digitized process is reengineered using the same approach.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for reengineering of at least one business process, comprising:
extracting baseline information requirements of said at least one business process; wherein the step of extracting comprises:
interviewing a process owner of each of said sub-processes of said at least one business process based on a predetermined questionnaire; and
quantifying information requirements of each of said sub-processes of said at least one business process based on said questionnaire;
displaying said baseline information requirements in a predetermined matrix structure; and
prioritizing opportunities for removing information bottlenecks in said at least one business process using said predetermined matrix structure.

2. The method according to claim 1, wherein said extracting further comprises:
identifying a plurality of high level sub-processes of said at least one business process;
obtaining process maps for each of said sub-processes of said at least one business process; and
obtaining all forms and documents used in each of said sub-processes of said at least one business process.

3. The method according to claim 1, wherein said extracting comprises extracting across a plurality of functions of said at least one business process.

4. The method according to claim 1, wherein said displaying comprises:
displaying said information in at least one row and at least one column of said predetermined matrix format; and
displaying said information in at least one cell of said predetermined matrix format.

5. The method according to claim 4, wherein said information in said at least one row comprises information related to a category of said baseline information.

6. The method according to claim 4, wherein said information in said at least one column comprises information related to where said baseline information is used.

7. The method according to claim 4, wherein said information in said at least one cell comprises information related to how said baseline information is obtained.

8. The method according to claim 4, wherein displaying said information further comprises coloring said at least one cell based on said baseline information in said cell, wherein said coloring is based on a predetermined coloring scheme.

9. The method according to claim 1, wherein said removing information bottlenecks comprises removing information bottlenecks using digitization.

10. The method according to claim 1, wherein said prioritizing comprises:
prioritizing based on a color of at least one row of said predetermined matrix; and
prioritizing based on a color of at least one column of said predetermined matrix.
prioritizing based on a color of at least one cell of said predetermined matrix.

11. The method according to claim 1, wherein said at least one business process comprises a core business process.

12. The method according to claim 1, wherein said reengineering comprises reengineering before digitization.

13. The method according to claim 1, wherein said at least one business process comprises process for a transactional business system.

14. The method according to claim 13, wherein said at least one business process comprises at least one of credit, sourcing, pricing or finance.

15. The method according to claim 1 further comprising sharing said information with at least one function of said at least one business process.

16. A system to reengineer at least one business process, comprising:
at least one questionnaire for interviewing an expert for eliciting baseline information requirement of said business process;
a plurality of documents related to said baseline information requirement of said business process; and
a matrix to display said baseline information requirement of said business process.

17. The system according to claim 16, wherein said at least one questionnaire comprises:
at least one question related to what baseline information is required;
at least one question related to why said baseline information is required;
at least one question related to how said baseline information is obtained; and
at least one question related to how said baseline information is intended to be used.

18. The system according to claim 16, wherein said plurality of documents comprises:
at least one process map of at least one sub-process of said business process;
at least one form related to said at least one sub-process of said business process.

19. The system according to claim 16, wherein said matrix comprises:
at least one row;
at least one column; and
at least one cell formed by an intersection of said at least one row and said at least one column.

20. The system according to claim 19, wherein said at least one row comprises information related to type of said baseline information.

21. The system according to claim 19, wherein said at least one column comprises information related to how said baseline information is obtained.

22. The system according to claim 21, wherein said baseline information comprises at least one of input information or output information.

23. The system according to claim 22, wherein said input information comprises at least one of manual or digitized input information.

24. The system according to claim 22, wherein said output information comprises at least one of manual or digitized output information.

25. The system according to claim 19, wherein said at least one cell comprises information related to how said baseline information is obtained.

26. The system according to claim 16, wherein said business process comprises a core process.

27. The system according to claim 16, wherein said business process comprises a Transactional business process.

28. The system according to claim 27, wherein said business process comprises at least one of credit, sourcing, pricing or finance.

29. The system according to claim 16, further comprising a coloring scheme conceptualized to color a cell of said matrix.

30. A business system framework, comprising:
multiple interrelated business processes for accomplishing a business objective, wherein the interrelated business processes each includes a plurality of resources that collectively perform a business task;
a business process reengineering system, including:
at least one questionnaire for interviewing an expert for eliciting baseline information requirement of said business process
a plurality of documents related to said baseline information requirement of said business process;
a matrix to display said baseline information requirement of said business process; and
a coloring scheme conceptualized to color a cell of said matrix.
